(19) United States
(12) Patent Application Publication
(10) Pub. No.: US 2004/0026338 A1
(43) Pub. Date: Feb. 12, 2004

(54) Method for filtration of a liquid, in particular for the filtration of beer, using a filter aid

(76) Inventors: Jean-Jacques Biebuyck, Rixensart (BE); Daniel Daoust, Chaumont-Gistoux (BE); Jacques Devaux, Belgrade (BE); Georges Rahier, Liege (BE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/415,485

(22) PCT Filed: Oct. 31, 2001
(86) PCT No.: PCT/EP01/12598

(30) Foreign Application Priority Data
Oct. 31, 2000 (EP) 00870258.1

(51) Int. Cl. C02F 1/72

(52) U.S. Cl. 210/758

(57) ABSTRACT

The invention relates to a filter aid for filtering a liquid, such as beer, in a filtration device working on a defined filtration velocity, said filter aid consists essentially of particles of a material A, wherein the flotation velocity U_{oA} is measured as Formula (I): wherein d_{A} is the diameter of the particle, μ is the viscosity of the fluid, r is the density of the fluid and ρₐ is the density of the particle. The invention further relates to the use of said filter aid as a precoating material in a candle filtration device and to the candle filtration device comprising a number of candles provided with a precoat consisting essentially of the filter aid according to the invention and to a filtrated liquid, for example alcohol and more in particular beer, obtained via a filtration method using a candle filtration device.

### FIELD OF THE INVENTION

The invention relates to method for the filtration of a liquid such as beer. The invention further relates to a filter aid suitable for said method for filtering a liquid such as beer and to its uses thereof.

### BACKGROUND OF THE INVENTION

In the processing of liquids and in particular of beer, filtration is a final step in their production.

The object of filtration is to remove all yeasts and colloidal particles in suspension in beer at the end of storage, ensuring a stable clarity in the final product. Filtration must take place at low temperature, if possible at −1° C., with a dissolved oxygen concentration less than 0.1 mg/l. Laminar flow should be ensured at the inlet and outlet of the filter and the adjustment of the CO₂ level in the beer should be performed at the outlet of the filter. The factors that affect filtration are particle size, diffusion, ionic charge, solubility, density, surface activity, etc. The size of particles in beer at the end of maturation is between 0.1 μm and a few μm, sometimes even larger. The quality of the filtered product should be optimal with regard to flavor, foam, brilliance, color and absence of microorganisms.

Extended lagering periods and the addition of flocculation aids both greatly reduce yeast and haze loadings. A final beer filtration is needed to remove residual yeast, other turbidity-causing materials in order to achieve colloidal and microbiological stability.

If there is a significant quantity of suspended material to be removed, powder filters using diatomaceous earth or perlite are employed. Although powder filters can produce beer of acceptable brilliance after a single filtration, a two-stage filtration process is needed for a final polish. Polish filtration may employ a sheet filter.

There are several types of powder filters: the plate and frame, the horizontal leaf, the vertical leaf, and the candle filter.

Yeast, protein, and carbohydrate particles must be removed from the beer to achieve the necessary clarity. As the first step in filtration, powder filters are used in conjunction with a filter aid for removing these suspended particles. The filter aid is generally injected at the point where the beer stream, together with the yeast and other suspended solids, forms an incompressible mass referred to as the “filter-cake.” The porous bed creates a surface that traps suspended solids, removing them from the beer. Filter aid, also referred to as “body-feed,” is continually added into the flow of beer to maintain the permeability of the cake. Not all of the particles will be trapped at the surface; some, especially the finer material, will pass into the filter cake and be trapped—a process referred to as “depth filtration.” Depth filtration is not as effective as surface filtration, but is still a significant mechanism of filtration by filter aids. Powder filtration is generally regarded as providing the most economical form of filtration. The cost of filter aids is quite low, and long filtration cycles at high flow rates are possible.

To achieve beer stability it is necessary to remove either the protein, the polyphenol, or both from the beer. These nonbiological haze precursors can be removed during the cold conditioning or filtration steps, i.e., during colloidal stabilization at the filter. During filtration, the most commonly used stabilizers for removing proteins is amorphous silica gel (e.g., Lucite®). Polyvinylpolypyrrolidone or PVPP (e.g., Polycar AT®) is typically used for removing polyphenols.

Incorporating stabilization treatments into the filtration process is increasingly popular. The most commonly used stabilizers are silica gels and PVPP. This is achieved by dosing with either a silica gel or PVPP during filtration. The contact time required for optimal performance is very important. To use stabilizers properly, you might have to install a buffer/surge tank and auxiliary dosing equipment.

Silica gel contact times run from three minutes (xerogels) to 20 minutes (hydrogels). It is important to also take into consideration the stabilizer particle size in relation to cake volume occupied within the filter bed.

PVPP can be used in a manner similar to silica gels. In larger breweries PVPP can be recovered and regenerated with caustic for reuse in filtration.

There are several types of depth filters available.

Pulp/Mass Filter: This type of filter was originally built by Enzinger in 1892. Round cakes (50 to 55 centimeters diameter, 5 tot 6 centimeters thick) of cellulose, asbestos, or a combination thereof are placed between frames. Beer is passed through the filter two to three times. The spent mass is removed, washed, and pressed into a new cake for reuse. These filters are labor intensive and not used very often (the exception being Coors Brewing Co. in Golden, Colo.).

Sheet Filters: In 1930 the Seitz company designed the EK (for entkeimung, a German word meaning sterilizing) filters allowing for microorganism-free filtered beer. These were cellulose and asbestos sheets 4.5 to 5 millimeters thick with varying pore sizes. Today asbestos is prohibited and stabilizers such as silica gels, PVPP and perlite have been incorporated. The smaller the pores of the filter sheets, the lower the rate of flow. It is up to the brewer to select the sheet depending on the beer composition. This filter commonly is used as a secondary filter after primary powder infiltration.

Powder Filters: The filter employs the dosing of powders (kieselguhr, or perlite) of varying size onto a support medium (cotton, cloth, plastic cloth, metal screens, or cylindrical metal candles) to form a filter bed. The three main filter types, plate-and-frame, candle and leaf filters.

At the end of the fermentation-maturation, the processed beer comprises a large quantity of yeast in a size between 6 and 9 μm, and a colloidal haze having a size less than 1.5 μm. In order to obtain a clarified beer of a good quality, it is sufficient to eliminate particles which are larger than 0.5 μm.

Such a clarifying filtration necessitates the use of filter aids such as the above mentioned kieselguhrs. These granular substances are essentially composed out of SiO₂ and they form during filtration a porous environment which is able in fixating these impurities to be eliminated and facilitates the outstream of the liquid phase. In modern installations these operations are performed in the above mentioned filtration device. These filtrating media are made of stainless material having an opening near 50-80 μm. Filtration is preferably performed with a constant flow rate.

Throughout the text flotation velocity is used. Some technical publications define the flotation velocity also as the terminal climbing velocity.

A first step in such a filtration consists in depositing on these filtrating media a precoat layer in general 2 to 3 mm thick which as formed by the filtration of a suspension of kieselguhr having a flow rate close to about 10 hl/h m². The permeability of this cake is within a magnitude of 10⁻² m². Said precoating is suitable for controlling the size of the meshes of the filtrating media and will favorize a detachment of the sediment cake after the filtration cycle. In a next step a second precoating is performed following a similar procedure as the one described above, for the first precoating having also a comparable thickness. Said second precoat has a permeability which is slightly less in a range of 0.02 to 0.3 10⁻¹² m². Said second precoating step results in a fixation of the very fine particles of a size of about 1 μm. Generally the kind of filter aid which is used during the second precoating is identical to the one used in alluviation.

The third step is a clarifying filtration, which is a step wherein the beer is at the latest stage of the maturation and is intimately mixed with kieselguhr prior filtration of the suspension.

The quality of the deposition of the precoating is of an extreme importance for the macrobiological quality and the turbidity of the beer. In order to assure a good settling of the filtration media it is preferred that D99.5 of the filter aid has a size which is superior to one third of the mesh opening. For minimizing the segregation effect of the particles it is convenient to control the ratio of the velocity of the liquid phase and the velocity of the sedimentation. This ratio must be superior to 2.5. This later criteria is very difficult to obtain when filtering using kieselguhr having a specific mass of 2400 kg/m³ and more.

As a remedy to this complex situation, EP-A-0246241 discloses the use of fiber in particular of cellulose however the use of cellulose fibers results in an inconvenience that cakes are formed whereof the porosity decreases when the pressure increases which is a serious inconvenience for the clarification process.

The invention is directed towards a method of filtration of a liquid using a filter aid wherein the above mentioned problems are not present or at least minimized. A further object of the invention is to obtain a high quality of the final product in relation to the yeast content and the turbidity, being an economic feasible and environmental compatible system.

Another object of the invention is to provide a method of filtration of a liquid using a filter aid, wherein said filter aid when in a filtration device, covers the filtrating surface in a homogeneous way, and this at the start up to the end of the filtration.

### SUMMARY OF THE INVENTION

The invention provides therefore a method of filtration of a liquid, using a filter aid, whereby the flotation velocity of said filter aid is smaller than or equal to the filtration velocity. The present invention further relates to a filter aid suitable in a method according to the invention, wherein at least the outer surface of the particles is at least partly oxidized. When said criteria are present no segregation occurs and the defined filter surface, for example candles, are covered homogeneously. The present invention further relates to the use of said filter aid in a method according to the invention and to a filtration device using said filter aid.

Preferred embodiment of the present invention will be further disclosed in detail hereunder. Examples are given which will further support the description.

### DETAILED DESCRIPTION

The present invention relates to a method for filtering a liquid, for example beer at the end of the secondary fermentation storage, comprising the steps of de-aeration, depositing a preliminary layer onto a filtration support and recirculation. Said method is characterized in that the filtration step is carried out using a using a filter aid which consists essentially of particles of material A, whereby the flotation velocity of said particles is smaller than or equal to the filtration velocity.

The relative proportions of the filter aid and the liquid to be filtered preferably vary between approximately 25 g of filter aid/hl of liquid and approximately 250 g of filter aid/hl of liquid.

In an embodiment the present invention, a method of filtration of a liquid using filter aid is provided wherein the flotation velocity of said filter aid is smaller than the filtration velocity.

This characteristic is translated in a non-working environment by the fact that the specific mass of said filter aid is less than or at least equal to the specific mass of the liquid. According to another embodiment, is provided a method of filtration of a liquid, wherein the specific mass of the filter aid is less than the specific mass of the liquid. For example the filter aid may have a specific mass less than 1100 kg/m³ and particularly less than 1000 kg/m³. These values depend on the specific mass of the liquid to be filtered, as they should at least equal or smaller to the mass of said liquid.

In said method of filtration these important characteristics of the filter aid employed, namely flotation velocity and specific mass smaller or at least equal to the filtration velocity and specific mass of the liquid, permit a homogeneous deposition of said filter aid and a homogeneous thickness of the cake on the filter device. Decantation and sedimentation of said filter aid is avoided during the filtration process, providing therefore an efficient filtration method.

In another embodiment said filter aid which consists of materials A may have a specific mass within 1 000-800 kg/m³, if we assume that the specific mass of the liquid such as beer is 1 000 kg/m³. Other examples of suitable ranges according to the invention include but are not limited to: 900-1 000 kg/m³, 900-990 kg/m³, 900-980 kg/m³, 900-970 kg/m³, 900-960 kg/m³, 900-950 kg/m³, 900-940 kg/m³.

Examples of material A suitable for said method include but are not limited to incompressible synthetic or natural polymer grains or incompressible natural grains made from, for example, polyamide, polyvinylchloride, fluorinated products such as TEFLON®; polypropylene, polystyrene; polyethylene such as HDPE, LDPE, MDPE, LLPDE, UHMWPE; polybutene; polymethylpentene; ethylene copolymers; binary copolymers and terpolymers with acrylics; Olefinic thermoplastic elastomers, certain derivatives of silica, for example ryolites or glass, and mixtures thereof. Polyamides that can be used in the context of the present invention include, for example, and without limiting the invention: polycaprolactam, poly(hexamethylene adipamide), poly(hexamethylene nonanediamide), poly(hexamethylene sebacamide), poly(hexamethylene dodecanodiamide), polyundecanolactam, polylauryllactam and/or mixtures thereof.

More in particular said material A may be chosen from the groups comprising polyethylene comprising: HDPE, LDPE, MDPE, LLPDE, UHMWPE; Polybutene; Polymethylpentene; Ethylene copolymers; binary copolymers and terpolymers with acrylics; Olefinic thermoplastic elastomers. According to another embodiment said filter aid may further comprise PVPP.

Moreover in the method according to the invention at least the outer surface of the particles constituting the filter aid is at least partly oxidized. The oxidation step may be obtained by reaction of putting said particles in a solution of hypochlorus acid (HClO) and/or its sodium (NaOCl) and/or potassium salts (KOCl) (for example a 15% solution). This oxidation step allows an increase of the hydrophilic character of the particle's surfaces for a good clarification of hydrophilic liquids. For the clarification of hydrophobic liquid, the surface of said particle may be rendered hydrophobic.

The method of the invention is particularly satisfactory when employed for the filtration of liquids with soluble organic components, such as wine, beer, cider and the like.

The present invention further relates to a filter aid suitable in a method according to the invention, for the filtration of a liquid, such as beer, wherein the particles of said filter aid are submitted to a surface treatment in order to increase its hydrophilic character. Any kind of treatment can be used but preferably said surface treatment is an oxidizing process wherein preferably a contacting step is present wherein the particles are brought into contact with a solution of hypochlorus acid (HClO) and/or its sodium (NaOCl) and/or potassium salts (KOCl) (for example a 15% solution).

According to an embodiment, the present invention relates to a filter aid as described above, in a filtration device working on a defined filtration velocity, wherein said filter aid consists essentially of particles of a material A, whereby the flotation velocity of said particles is smaller than or equal to said filtration velocity. According to another embodiment, the flotation velocity of said particles is smaller than or equal to the filtration velocity.

In an embodiment the filter aid according to the invention has a specific mass which is less than or at least equal to the specific mass of the liquid to be filtrated. In another embodiment the invention relates to a filter aid as described above which may be made from a material A which is chosen from the group:

Polyethylene, for instance:

Low Density Polyethylene (LDPE),

Medium Density Polyethylene (MDPE),

High Density Polyethylene (HDPE),

Linear Low Polyethylene (LLPDE),

Ultra High Molecular Weight Polyethylene (UHMWPE);

Polybutene;

Polymethylpentene;

Any kind of copolymer or terpolymer and any kind of polymer blends with said specific mass characteristics, for example:

Ethylene copolymers such as copolymers with vinyl acetate, copolymers with vinyl alcohol;

Binary copolymers and terpolymers with acrylics;

Olefinic thermoplastic elastomers.

According to another embodiment said filter aid may further comprise polyvinylpyrrolidone (PVPP).

The filter aid of the present invention are preferably of foodstuffs grade and resistant to dilute acid and alkaline solutions. They also have sufficient resistance to abrasion, to the regeneration agents and to temperatures in the order of 100° C. They are also undeformable due to the effect of the filtration pressure.

The filter aid suitable in the methods of the invention can have a specific mass less than 1100 kg/m³ and preferably less than 1000 kg/m³. These values depend on the specific mass of the liquid to be filtered, as these should at least equal or smaller to the mass of said liquid. This important characteristic of said filter aid allows a homogeneous deposition of the filter aid and a homogeneous thickness of the cake on the filter device and sedimentation and decantation of said filter aid is avoided. For example materials A may have a specific mass within 1 000-800 kg/m³, if we assume that the specific mass of the liquid such as beer is 1 000 kg/m³. Other examples of suitable ranges according to the invention include but are not limited to: 900-1 000 kg/m³, 900-990 kg/m³, 900-980 kg/m³, 900-970 kg/m³, 900-960 kg/m³, 900-950 kg/m³, 900-940 kg/m³.

In another embodiment a filter aid according to the invention is provided wherein the shape factor of the particle, measured with microscopy means, defined by the ratio between the smallest and the largest diameter sizes is on average between 0.4 and 0.8 and preferably close to 0.6.

In another embodiment a filter aid is provided wherein the particles form a granular medium or cake having a porosity of between 0.4 and 0.6 and a permeability of at least 0.4 Darcy.

In another embodiment a filter aid is provided wherein the volumic particle size distribution of the particles is defined by an average diameter of between 25 and 40 μm (Cilas measurement) and by the fact that 60% of the particles have a diameter between 15 and 50 μm.

In another embodiment a filter aid is provided obtainable via a grinding step, preferably a cryogenic grinding step and a sieving step with a sieve having a mesh size from 50 to 90 μm, preferably from 50 to 80 μm, more preferably 80 μm

The present invention further relates to the use of a filter aid as described above, in a method of filtration according to the invention. Moreover, the present filter aid may be used as a precoating material in a filtration device. For example said filter aid may be in a candle filtration device.

The filter aid according to the invention is in particular useful in candle filtration devices.

The present invention also relates to a filtration device using the filter aid of the present invention. Examples of such devices include but are not limited to metal sheet (leaf, screen or plane), cellulose sheets, plate or candle filtration devices. More in particular the present invention relates to a candle filtration device comprising a number of candles provided with a precoat consisting essentially of the filter aid of the present invention.

The present invention also encompasses filtrated liquids, such as for example alcohol and more in particular beer, obtained via a filtration method according to the invention using a filtration device such as a candle filtration device.

All these advantages will be elucidated hereunder wherein preferred embodiments and examples of the invention are explained.

In another embodiment the invention is related to the use of a filter aid, wherein at least its outer surface has been oxidized, as a precoat having a material of which the specific mass is less than the specific mass of the liquid or the suspension to be filtrated. More in particular the filter aid according to the invention is made of a material or is made of particles of a material whereby the flotation velocity of the particles is less than or equal to the filtration velocity.

The flotation velocity U_{oA} can be measured as:

$${U}_{oA} = \frac{{d}_{A}^{2} g}{18 μ} ( ρ - {ρ}_{A} )$$

wherein d_{A} is the diameter of the particle, μ is the viscosity of the fluid, ρ is the density of the fluid and ρ_{A} is the density of the particle. This results in an annihilation of the sedimentation effects. In a another embodiment HDPE is used which is a material useful in the feeding industry having a suitable resistance to the products used in beer filtration such as acids, alkali, detergents, (and this up to a temperature of more than 100° C.). The specific mass of this material is near to 940 kg/m³. The man skilled in the art could consider the use of a similar material, as mentioned above, having the characteristics that the solid phase of the filter cake would not recover the whole surface of the filtrating area and having the same flotation effect. The filtration velocity is kept constant, because the two relevant parameters, i.e. the flowrate and the filtration area are constant.

In a preferred embodiment the HDPE polymer is cryogenically ground and sieved over a sieve having a mesh size from 50 to 80 μm. The sieved fraction is used as a filter aid according to the invention. The granulometry (volumic particle size distribution) of these particles is measured via the granulometer laser Cilas in an alcoholic environment. Following results were obtained:

| | Sieve 50 micron | Sieve 80 micron |
|---|---|---|
| D 10 | 10.47 micron | 18.86 micron |
| D 50 | 34.19 micron | 52.50 micron |
| D 90 | 56.47 micron | 83.58 micron |

A microscopic analysis of 297 particles which would result of the cryogenic grinding process over a sieve of 80 microns resulted in:

| | | |
|---|---|---|
| average area of the particles | 12.46 microns² | standard deviation: 33.73 |
| average perimeter | 15.68 microns | standard deviation: 16.05 |
| average maximum diameter | 4.33 microns | standard deviation: 3.93 |
| average minimum diameter | 2.77 microns | standard deviation: 2.66 |

This HDPE polymer is hydrophobic and has a natural tendency in foaming in an aqueous environment. Furthermore, this situation could cause damage to essential pieces in the filter apparatuses and need therefore to be eliminated. In order to obtain a hydrophilic material it is a possibility to treat the surface of the particle of the filter aid with an oxidation step. Several HDPE materials have a resistance towards a solution of NaOCl/KOCl up to a temperature of 60° C. The ground material (200 g) is put in suspension in one liter of sodiumhypochloride 15%. The suspension is brought up to 91° C. during 17 h. The suspension is filtrated and the obtained filtrate is washed with demineralized water. This treatment renders the particles according to the invention even more suitable and more homogeneously divided over the total filtration surface of the candles.

### EXAMPLE 1

An experimental test is made with a filter aid according to the invention on a candle type Filtrox wherein the calibrated openings are from 50 to 70 μm. The diameter of the candle is 30.1 mm and the filtrating height is 38.6 cm. The candle is being placed in a filtration device under pressure having an inside diameter of 100 mm.

The filtration candle proper consists of eight longitudinal profiled elements on which is wound a radial profiled element with a precisely maintained gap between the windings. Any displacement of the radial profile is prevented by connections welded to the longitudinal elements. The radial gap is open towards the interior (angle about 200). Because of this the particles remain fixed on the outside or migrate inwards as a result of the widening of the surface of the candle. Obstruction of the filtration candles by kieselguhr particles is thus prevented. The filtration candle has a very smooth surface which is resistant to impacts. This makes it easier for the sludge to slide off during the cleaning phase.

The inventors have prepared a suspension of 155 g of the filter aid of material HDPE, which is sieved with a 80 μm mesh and treated with NaOCl solution in 20 liter of water and this suspension is used for filtration having a flow rate of 0.6 liter per minute. Prior the filter is filled with water. The filtration velocity, which is the ratio of the suspension flowrate and the surface of the filtrating media, was 274.1 10⁻⁶ m/s. The flotation velocity was 228.42 10⁻⁶ m/s for the D90 (83.58 μm). These values were measured with water at 20° C. with a viscosity of 0.001 Pa.s.

When the deposition is ended the inventors have measured a pressure difference of 1600 Pascal. The turbidity measured from the preparation of the filtration device to the outflow of the suspension is 0.065 EBC, which is surprisingly a very small value. Afterwards the candle provided with filter aid is removed and the thickness of the cake measured from the top of the candle towards the end and resulted in:

| | |
|---|---|
| At the top of the candle | 7 mm |
| at 1 cm from the top | 6 mm |
| at 2 cm from the top | 6 mm |
| at 3 cm from the top | 6 mm |
| at 10 cm from the top | 8 mm |
| at 15 cm from the top | 8 mm |
| at 20 cm from the top | 8 mm |
| at 25 cm from the top | 7 mm |
| at 30 cm from the top | 7 mm |
| at 35 cm from the top | 7 mm |
| at 38.5 cm from the top | 7 mm |

The average thickness of the cake on the candle is 7.01 mm (standard deviation: 0.7 mm). The permeability of the cake is 1.066 10⁻¹² m². These results prove the efficacy of the filter aid according to the invention.

### Example 2

A similar example is performed using a traditional, known filter aid also known as Difbo® which is brought on the market via the firm CECA. The average thickness of the cake is 5 mm and for the deposition of 117 g filter aid put in suspension in 22.5 liters water. At the top of the candle the inventors have noticed that some of the filtration surfaces is not being provided with the filter aid. At one cm of the top of the filtration zone the cake has only a thickness of 1 mm, on two centimeter 3 mm and on three centimeter of the top 3.7 mm. The turbidity when the container is empty is 9.1 EBC, the permeability is 0.7. 10⁻¹² m. These good results of a filter aid according to the invention indicate that only one precoat step is necessary in order to obtain excellent turbidity results, which is not the case with the known filter aids. The use of other filtration areas, for example in metal sheet (leaf, screen or plate) filters are also available. Experiments with a sieving operation on screen size 50 μm and experiments with a HDPE/PVPP mixture have led to similar results. A further quality of the filtration according to the invention is that hydrated PVPP (1086 kg/m³) and the material of the filter aid can easily be separated via for example a decantation.

Obviously, numerous modifications and variations of the present invention are possible in the light of the above teachings. It is therefore to be understood that within the scope of the appended claims, the invention may be practiced otherwise than as specifically described herein.

1. Method of filtration of a liquid, using a filter aid whereby the flotation velocity of said filter aid is smaller than or equal to the filtration velocity of the liquid.

2. Method according to claim 1 using a filter aid which consists essentially of particles of material A, whereby the flotation velocity of said particles is smaller than or equal to the filtration velocity.

3. Method according to any of claims 1 or 2 wherein the flotation velocity of said filter aid is smaller than the filtration velocity.

4. Method according to any of claims 1, 2 or 3, wherein the specific mass of said filter aid is less than or at least equal to the specific mass of the liquid.

5. Method according to claim 4, wherein the specific mass of said filter aid is less than the specific mass of the liquid.

6. Method according to any of the previous claims 1-5, wherein said material A is chosen from the groups: polyethylene comprising: HDPE, LDPE, MDPE, LLPDE, UHMWPE; Polybutene; Polymethylpentene; Ethylene copolymers; binary copolymers and terpolymers with acrylics; Olefinic thermoplastic elastomers.

7. Method according to any of the previous claims 1-6, where the filter aid has a specific mass less than 1100 kg/m³ and preferably less than 1000 kg/m³.

8. Method according to any of the previous claims 1-7, wherein at least the outer surface of the particles is at least partly oxidized.

9. Method according to claim 8, wherein the oxidation is obtained by reaction of putting said particles in a solution of KOCl and/or NaOCl.

10. Method according to any of the previous claims 1-9, wherein said filter aid further comprises PVPP.

11. Filter aid suitable in a method according to any of claims 1-10, wherein at least the outer surface of the particles is at least partly oxidized.

12. Filter aid according to claim 11, wherein the oxidation is obtained by reaction of putting said particles in a solution of KOCl and/or NaOCl.

13. Filter aid according to any of claims 11 or 12, for the filtration of a liquid, such as beer, in a filtration device working on a defined filtration velocity, wherein said filter aid consists essentially of particles of a material A, whereby the flotation velocity of said particles is smaller than or equal to said filtration velocity.

14. Filter aid according to claim 13, whereby the flotation velocity of said particles is smaller than or equal to the filtration velocity.

15. Filter aid according to any of the previous claims 11-14, wherein the specific mass of the filter aid is less than or at least equal to the specific mass of the liquid.

16. Filter aid according to any of the previous claims 15, wherein the specific mass of the filter aid is less than the specific mass of the liquid.

17. Filter aid according to any of the previous claims 11-16, wherein the material A is chosen from the groups: PE comprising: HDPE, LDPE, MDPE, LLPDE, UHMWPE; Polybutene; Polymethylpentene; Ethylene copolymers; binary copolymers and terpolymers with acrylics; Olefinic thermoplastic elastomers.

18. Filter aid according to any of the previous claims 11-17, wherein the shape factor, measured with microscopic means, defined by the ratio between the smallest and the largest diameter sizes is on average between 0.4 and 0.8 and preferably close to 0.6.

19. Filter aid according to any of the previous claims 11-18, wherein the particles form a granular medium or cake having a porosity of between 0.4 and 0.6 and a permeability of at least 0.4 Darcy.

20. Filter aid according to any of the previous claims 11-19, wherein the volumic particle size distribution is defined by an average diameter of between 25 and 40 μm (Cilas measurement) and by the fact that 60% of the particles have a diameter between 15 and 50 μm.

21. Filter aid according to any of the previous claims 11-20, obtainable via a grinding step, preferably a cryogenic grinding step and a sieving step with a sieve having a mesh from 50 to 90 μm.

22. Filter aid according to any of the previous claims 11-21, having a specific mass less than 1100 kg/m³ and preferably less than 1000 kg/m³.

23. Filter aid according to any of the previous claims 11-22, further comprising PVPP.

24. Use of a filter aid according to any of the previous claims 11-23, in a method of filtration according to any of claims 1 to 10

25. Use of a filter aid according to any of the previous claims 11-23 as a precoating material in a filtration device.

26. Use according to claim 25, wherein said device is a candle filtration device.

27. Filtration device using a filter aid according to any of the previous claims 11-23.

28. Candle filtration device comprising a number of candles provided with a precoat consisting essentially of the filter aid according to any of the previous claims 11-23.

29. Filtrated liquid, for example alcohol and more in particular beer, obtained via a filtration method according to any of claims using a filtration device according to any of claims provided with a filter aid according to any of the previous claims 11-23

30. Filtrated liquid, for example alcohol and more in particular beer, obtained via a filtration method according to any of claims using a candle filtration device having candles provided with a precoat according to any of the previous claims 11-23.
